(19) United States
(12) Patent Application Publication
(10) Pub. No.: US 2015/0039518 A1
(43) Pub. Date: Feb. 5, 2015

(54) PERSONALIZED MARKETING SYSTEM AND PERSONALIZED MARKETING METHOD

(71) Applicant: IADEA CORPORATION, Taipei (TW)

(72) Inventors: Chia-Chin Wang, Taipei City (TW); Yung-Chieh Lin, Taipei City (TW)

(73) Assignee: IADEA CORPORATION, Taipei (TW)

(21) Appl. No.: 13/957,412

(22) Filed: Aug. 1, 2013

(51) Int. Cl. G06Q 30/02; G06Q 20/38

(52) U.S. Cl. CPC G06Q 30/0269; G06Q 30/0267; G06Q 20/3829
USPC 705/71; 705/14.64

(57) ABSTRACT

The present invention provides a personalized marketing system and a personalized marketing method. The personalized marketing system comprises: a display device, a detecting device, a database device, and a control device. The display device is utilized for displaying at least an information. The detecting device is utilized for detecting at least a viewer via at least a wireless signal that can identify the viewer. The database device is utilized for recording data of connections between the information and the detected viewer. The control device is utilized for controlling the display device to display a specific information according to the data recorded in the database device.

### BACKGROUND OF THE INVENTION

1. Field of the Invention

The present invention relates to a personalized marketing system and a personalized marketing method, and more particularly, to a personalized marketing system and a personalized marketing method which can let media owners increase the competitive strength of their media, and attract viewers to watch and use the media, and precisely quantify the effectiveness of the media by collecting the anonymous viewer information and controlling a display device to display targeted information and avoid displaying repeated or useless information.

2. Description of the Prior Art

Analyzing the flow of people is critically needed for optimizing the design of public spaces including physical locations such as retail locations, transportation, etc., and virtual online locations such as websites. In addition, analyzing their movement after certain event (having played a video message, or having added a visual sign, or having renovated a store) is critical in measuring the effectiveness of the action in achieving results. In recent years, the technology for tracking people in the online space improved drastically through services such as Google Analytics, which is able to offer website administrators insights into how users browse the content of their website, how long they stay on specific web page, whether they are new or return visitors, and what they did after they have seen a web ad. Such information has proven critical in the optimization of web sites and web-based stores. In the real world, similar attempts have been made. Historically video cameras and thermal sensors have been used to determine the “heat map” of a space by color coding areas of most and least footfall traffic. The problem of such technique is that individual usage patterns cannot be accurately determined, such as the frequency of repeat visits by a user or duration of stay. To solve the problem, retail stores invented membership cards that allowed the retailer to understand individual purchase patterns. However, it cannot track those who visit or pass by the store without making a purchase, which is needed for insights into how a store may optimize its design to increase the rate of purchase.

Another attempt uses mobile phone signals (GSM, CDMA, etc.) to determine the location of the user. However while such attempts can uniquely identify individual behavior, and does not require the user to make a purchase, the precision of the location information is often less than desirable due to the range of mobile phone networks, and such technology is often licensed and available only to limited few mobile network operators. Recently a new technique uses free WiFi service offered in-store shoppers to log in to the network (such as U.S. Pat. No. 8,427,977), at which point the WiFi service can then track the individual user each time he comes in contact with the network. By deploying multiple access points to create multiple WiFi zones, the system can monitor how users travel from one zone to another. However, the technique requires users to sign in to the WiFi network (“broadcasting units are each configured with the respective transmitter and configured to receive and transmit information from the use”, U.S. Pat. No. 8,301,126), and with the increased popularity of mobile data service, fewer people have the incentive to make the effort to sign in. Yet another method (U.S. Pat. No. 8,433,342) requires the user to download a mobile application. The problem of such method is that most users do not want the hassle of installing an additional mobile application on their phone, and therefore the coverage of the method may be limited.

### SUMMARY OF THE INVENTION

It is therefore one of the objectives of the present invention to provide a personalized marketing system and a personalized marketing method which can let media owners increase the competitive strength of their media, and fascinate viewers to watch and use the media, and precisely quantify the dissemination effects of the media by collecting the anonymous viewer information and controlling the display device to display targeted information and avoid displaying repeated or useless information, so as to solve the above problem.

In accordance with an embodiment of the present invention, a personalized marketing system is disclosed. The personalized marketing system comprises: a display device, a detecting device, a database device, and a control device. The display device is utilized for displaying at least an information. The detecting device is utilized for detecting at least a viewer via at least a wireless signal that can identify the viewer. The database device is utilized for recording data of connections between the information and the detected viewer. The control device is utilized for controlling the display device to display a specific information according to the data recorded in the database device.

In accordance with an embodiment of the present invention, a personalized marketing method is disclosed. The personalized marketing method comprises: utilizing a display device for displaying at least an information; detecting at least a viewer via at least a wireless signal that can identify the viewer; recording at least a data of connections between the information and the detected viewer; and controlling the display device to display a specific information according to the data recorded in the database device.

Briefly summarized, the personalized marketing system and the personalized marketing method disclosed by the present invention can let media owners increase the competitive strength of their media, and attract viewers to watch and use the media, and precisely quantify the effectiveness of the media by collecting the anonymous viewer information and controlling the display device to display targeted information and avoid displaying repeated or useless information, so as to solve the problems of conventional marketing system and marketing method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a personalized marketing system in accordance with an embodiment of the present invention.

FIG. 2 is a flowchart showing a personalized marketing method of an embodiment in accordance with the above operation schemes of the personalized marketing system in FIG. 1 of the present invention.

FIG. 3 shows a simplified block diagram of a space 290 comprising three personalized marketing system having the same functions of the personalized marketing system in FIG. 1 in accordance with an embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

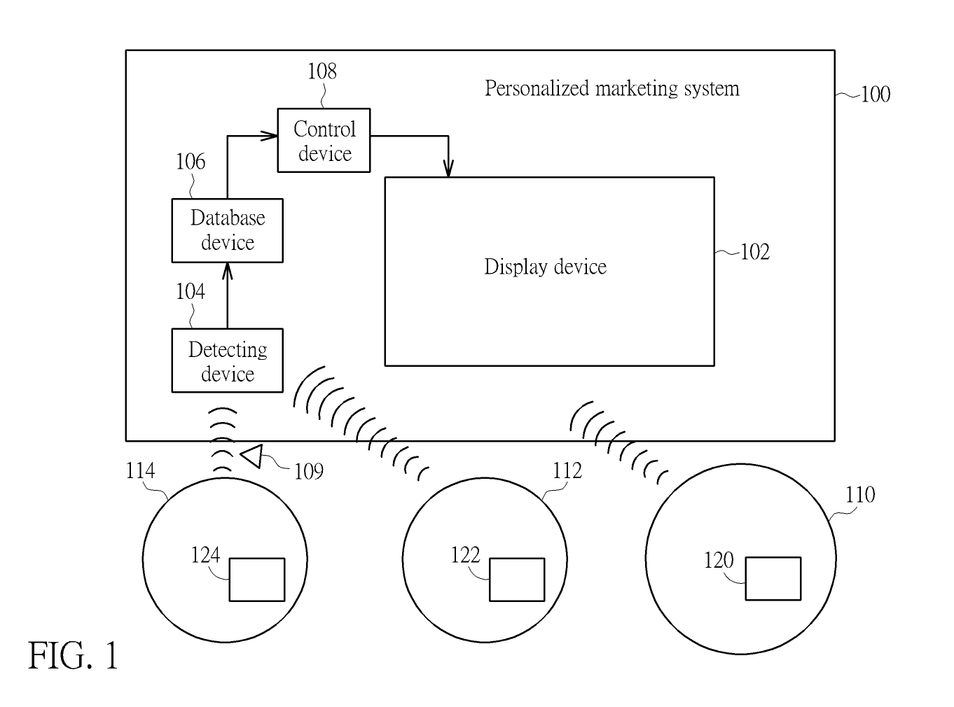

Please refer to FIG. 1. FIG. 1 shows a simplified block diagram of a personalized marketing system 100 in accordance with an embodiment of the present invention. As shown in FIG. 1, the personalized marketing system 100 comprises: a display device 102, a detecting device 104, a database device 106, and a control device 108. The display device 102 is utilized for displaying at least an information, wherein the at least an information can be video, audio, or image. The display device 102 may be a screen in a public space for shared viewing, or a screen of a mobile phone where the targeted information is delivered for personal viewing.

The detecting device 104 is utilized for detecting a plurality of viewers at a location within the detection range of detection device 104 via a plurality of wireless signals that can identify each viewer individually, wherein the viewers have mobile electronic devices (such as smart phones or plate computers) emitting the wireless signals, and the detecting device 104 detects the viewers by detecting the mobile electronic devices of the viewers and generating a plurality of unique keys, wherein each unique key is for each of the mobile electronic devices, wherein the wireless signals can be WiFi data frames used for discovery of a WiFi access point 109, or the wireless signals can be WiFi data frames carrying conversations between the mobile electronic devices and a WiFi access point 109 with which connection has been established. The database device 106 is utilized for recording data of connections between the information and the detected viewers. The control device 108 is utilized for controlling the display device 102 to display a specific information according to the data recorded in the database device 106.

For example, in FIG. 1, the detecting device 104 is utilized for detecting viewers 110, 112, 114 within the detecting range of detection device 104 via a plurality of wireless signals that can identify each of the viewers 110, 112, 114 individually, wherein the viewers 110, 112, 114 have mobile electronic devices 120, 122, 124 emitting the wireless signals, and the detecting device 104 detects the viewers 110, 112, 114 by detecting the mobile electronic devices 120, 122, 124 of the viewers 110, 112, 114 and generating 3 unique keys, wherein each unique key is for each of the mobile electronic devices 120, 122, 124, wherein the detecting device 104 can detect the mobile electronic devices 120, 122, 124 by monitoring MAC addresses of the mobile electronic devices 120, 122, 124. In addition, in order to avoid privacy intrusion of the viewers 110, 112, 114, the detecting device 104 can generate the unique keys for each of the mobile electronic devices 120, 122, 124 by encrypting the MAC addresses with a one-way secure hash algorithm that provides the unique keys to trace the viewers 110, 112, 114 without revealing the MAC addresses of the mobile devices 120, 122, 124. In this way, the present invention does not have to request the viewers to log in the network provided by the WiFi access point 109 or download an additional mobile application like the prior arts do. Or, the detecting device 104 also can drive the mobile electronic devices 120, 122, 124 to access reserved IP addresses defined by IETF RFC 6890 to uniquely associate the MAC addresses of the mobile electronic devices 120, 122, 124 with personal identifying information, wherein the reserved IP addresses are purposely chosen invalid IP addresses that will not be mistaken as a genuine network access. Such association can be established by asking the viewers 110, 112, 114 to access a specific web page from their mobile devices 120, 122, 124. The improvement over existing mechanisms is that on the landing web page, a piece of code (often part of the web page and written in Javascript language) drives the viewer's device to access a special IP address, which exposes a special signature that can be detected by detecting device 104 described above. One of such special patterns is a purposely chosen invalid IP address that will not be mistaken as a genuine network access. Such invalid (or reserved) IP addresses are listed in the IETF RFC 6890. Please note that the above embodiment is only for an illustrative purpose and is not meant to be a limitation of the present invention. For example, the numbers of the viewers and the mobile electronic devices can be changed according to different conditions.

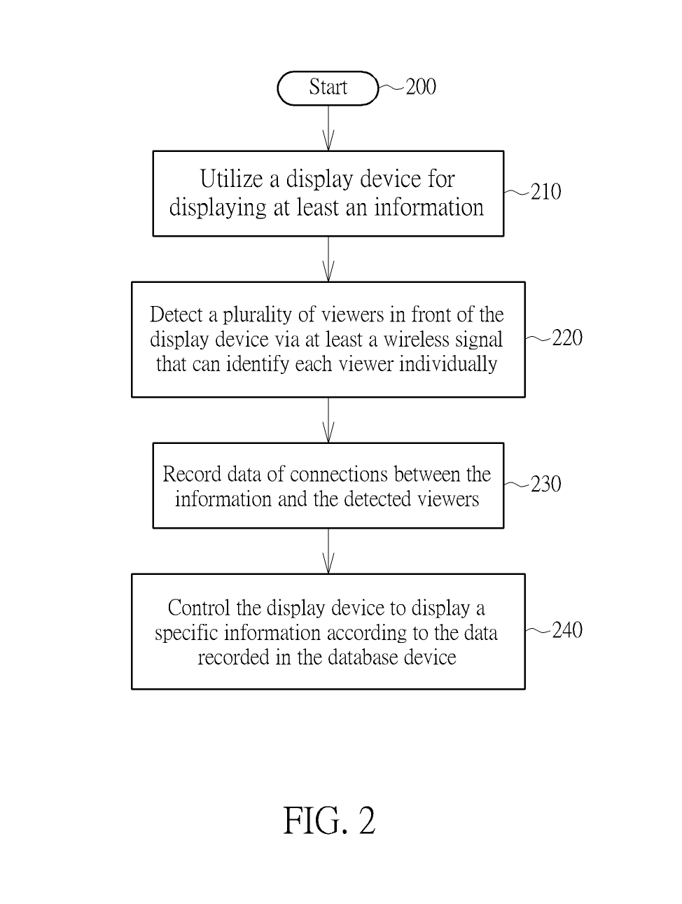

Please refer to FIG. 2. FIG. 2 is a flowchart showing a personalized marketing method of an embodiment in accordance with the above operation schemes of the personalized marketing system 100 of the present invention. Provided that substantially the same result is achieved, the steps of the process flowchart need not be in the exact order shown in FIG. 2 and need not be contiguous, that is, other steps can be intermediate. The personalized marketing method of the present invention comprises the following steps:

Step 200: Start.

Step 210: Utilize a display device for displaying at least an information.

Step 220: Detect a plurality of viewers at a location via at least a wireless signal that can identify each viewer individually.

Step 230: Record data of connections between the information and the detected viewers.

Step 240: Control the display device to display a specific information according to the data recorded in the database device.

Based on the anonymous viewer information collected above, the personalized marketing system 100 that displays dynamic visual advertisement or information can then have a lot of functions. For example, the personalized marketing system 100 can reliably determine how long does a person stay to watch the advertisement; the personalized marketing system 100 can serve multiple versions of an advertisement and determine which one attract the most attention; the personalized marketing system 100 can serve advertisements common to the interest of the viewers present based on their identity; the personalized marketing system 100 can serve advertisements about promotion in another area, and track if the advertisements really drives viewers that way; the personalized marketing system 100 can avoid repeating advertisements that the viewer has already seen.

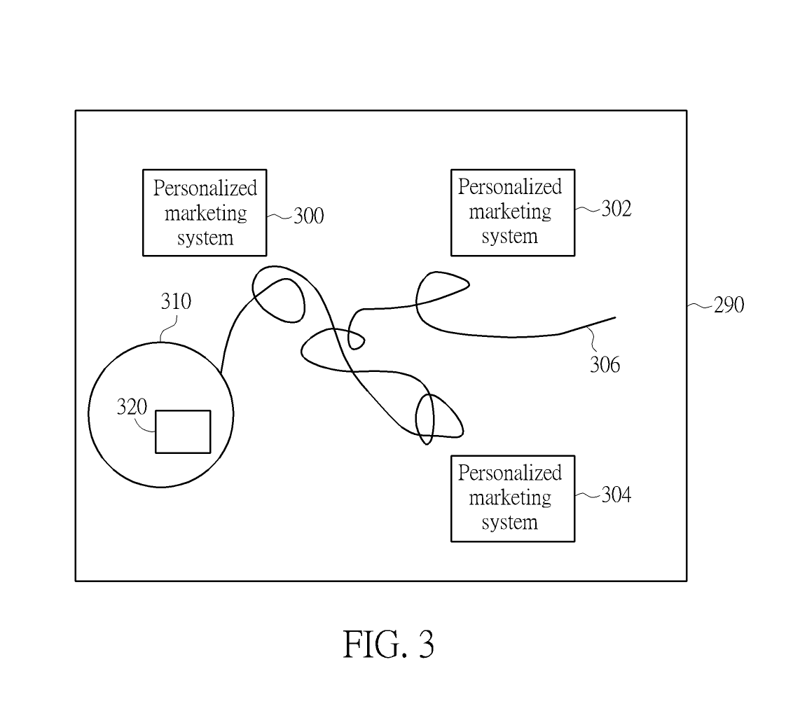

Please refer to FIG. 3. FIG. 3 shows a simplified block diagram of a space 290 comprising three personalized marketing system 300, 302, 304 having the same functions of the personalized marketing system 100 in accordance with an embodiment of the present invention. As shown in FIG. 2, a path 306 of a viewer 310 having a mobile electronic device 320 can be mathematically constructed by utilizing the functions of the personalized marketing systems 300, 302, 304 mentioned above. The amount of information that can be derived from the basic data of the path 306 is limitless, and of tremendous value to a planner of the flow in the space 290. For example, the personalized marketing systems 300, 302, 304 can show how the viewer 310 travels between the location of the personalized marketing systems 300, 302, 304; the personalized marketing systems 300, 302, 304 can show how long the viewer 310 stays in the proximity of one of the personalized marketing systems 300, 302, 304; the personalized marketing systems 300, 302, 304 can show how long before the viewer 310 returns to one of the personalized marketing systems 300, 302, 304 again after the viewer 310 departs from one of the personalized marketing systems 300, 302, 304.

In addition, a process of determining the effectiveness of a video message that is intended to drive the viewer 310 to move from a first location (for example, a location near the personalized marketing systems 300 in FIG. 3) to a second location (for example, a location near the personalized marketing system 302 in FIG. 3) can be performed by: playing a first video in the first location; sensing and recording the identity of the viewer 310; if the personalized marketing system 302 senses the identity of the viewer 310 within a fixed period, the video is determined to be effective in driving the viewer 310 to move into the second location. On the other hand, the present invention can play videos that have been determined as effective when there is requirement of driving people to the second location. Please note that the above embodiment is only for an illustrative purpose and is not meant to be a limitation of the present invention. For example, the numbers of the personalized marketing systems, the viewers and the mobile electronic devices can be changed according to different conditions.

Briefly summarized, the personalized marketing system and personalized marketing method disclosed by the present invention can let media owners increase the competitive strength of their media, and attract viewers to watch and use the media, and precisely quantify the effectiveness of the media by collecting the anonymous viewer information and controlling the display device to display targeted information and avoid displaying repeated or useless information, so as to solve the problems of conventional marketing system and marketing method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A personalized marketing system, comprising:
a display device, for displaying at least an information;
a detecting device, for detecting at least a viewer via at least a wireless signal that can identify the viewer;
a database device, for recording at least a data of connections between the information and the detected viewer; and
a control device, for controlling the display device to display a specific information according to the data recorded in the database device.

2. The personalized marketing system of claim 1, wherein the viewer has a mobile electronic device emitting the wireless signal, and the detecting device detects the viewer by detecting the mobile electronic device of the viewer and generating a unique key for the mobile electronic device.

3. The personalized marketing system of claim 2, wherein the wireless signal is a WiFi data frame used for discovery of at least a WiFi access point.

4. The personalized marketing system of claim 2, wherein the wireless signal is a WiFi data frame carrying at least a conversation between the mobile electronic device and at least a WiFi access point with which connection has been established.

5. The personalized marketing system of claim 2, wherein the detecting device detects the mobile electronic device by monitoring a MAC address of the mobile electronic device.

6. The personalized marketing system of claim 5, wherein the detecting device generates the unique key for the mobile electronic device by encrypting the MAC address with a one-way secure hash algorithm.

7. The personalized marketing system of claim 5, wherein the detecting device drives the mobile electronic device to access a reserved IP address defined by IETF RFC 6890 to uniquely associate the MAC address of the mobile electronic device with personal identifying information.

8. The personalized marketing system of claim 1, wherein the information is video, audio, or image.

9. The personalized marketing system of claim 1, wherein the control device further controls the display device to avoid displaying a repeated information.

10. The personalized marketing system of claim 1, wherein the control device further controls the display device to display a targeted information which corresponds to the most viewers detected in front of the display device.

11. A personalized marketing method, comprising:
utilizing a display device for displaying at least an information;
detecting at least a viewer via at least a wireless signal that can identify the viewer;
recording at least a data of connections between the information and the detected viewer; and
controlling the display device to display a specific information according to the data recorded in the database device.

12. The personalized marketing method of claim 11, wherein the viewer has mobile electronic device emitting the wireless signal, and the personalized marketing method detects the viewer by detecting the mobile electronic device of the viewer and generating a unique key for the mobile electronic device.

13. The personalized marketing method of claim 12, wherein the wireless signal is a WiFi data frame used for discovery of at least a WiFi access point.

14. The personalized marketing method of claim 12, wherein the wireless signal is a WiFi data frame carrying at least a conversation between the mobile electronic device and at least a WiFi access point with which connection has been established.

15. The personalized marketing method of claim 12, wherein detecting the mobile electronic device is performed by monitoring a MAC address of the mobile electronic device.

16. The personalized marketing method of claim 15, wherein generating the unique key for the mobile electronic device is performed by encrypting the MAC address with a one-way secure hash algorithm.

17. The personalized marketing method of claim 15, further comprising:
driving the mobile electronic device to access a reserved IP addresses defined by IETF RFC 6890 to uniquely associate the MAC address of the mobile electronic device with personal identifying information.

18. The personalized marketing method of claim 11, wherein the at least an information is video, audio, or image.

19. The personalized marketing method of claim 11, further comprising:
controlling the display device to avoid displaying a repeated information.

20. The personalized marketing method of claim 11, further comprising:
controlling the display device to display a targeted information which corresponds to the most viewers detected in front of the display device.
